(19) United States
(12) Patent Application Publication
(10) Pub. No.: US 2002/0085699 A1
(43) Pub. Date: Jul. 4, 2002

(54) Internet voice call back using call originating management technology

(76) Inventor: Brian Patrick Sullivan, Mount Kisco, NY (US)

Correspondence Address: VENABLE, Post Office Box 34385, Washington, DC, 20043-9998, US

(21) Appl. No.: 09/749,398

(22) Filed: Dec. 28, 2000

(51) Int. Cl. H04M 3/42; G06F 15/16; H04L 12/66

(52) U.S. Cl. 379/210.01; 370/352; 709/249

(57) ABSTRACT

A voice call back system for a user connected to a web server. In response to a user response to a prompt or icon on the screen of the user's terminal, the server downloads a call back screen to be filled in by the user. The name and telephone number of the user are entered by the user on the screen along with a user selected call back time. This data is transmitted to the web server. An application on the server converts this data to a format required by a call manager server in the call originating management system. The call manager creates a call record and appends the call record to the file of an active outbound campaign. The call manager sends the call record to a call processor in accordance with the user's instructions, and the call processor dials the user phone number, connects the call to an agent, and displays information relevant to the call on the display screen of the agent's terminal.

### BACKGROUND OF THE INVENTION

This invention relates to a system for providing voice call back in response to a user request entered via a terminal connected to a web server, and more particularly to a system that uses call originating management to schedule and place the call back.

Call origination management systems automatically dial clients, listen for the call result (i.e., ringing, busy signal, answer, no answer, etc.) and when a call results in an answer, automatically transfer the call to an available operator. Such systems are in general use today by a variety of businesses, groups and organizations.

The first step in beginning a calling campaign is to obtain the calling data, typically via tapes, disks, or through a communication link to a host computer. The data is input, and the system then organizes the data into the records for the campaign. When the campaign is started, the data is loaded into the “input call list.” The system then preloads a dialing queue with a certain number of records from the calling data. As the dialing process begins, the system manages the number of calls being made at any one time based on the number of operators that are available to receive calls. When a connection is established to a client, the system routes the call to an available operator and displays the client's record on the operator screen. The operator is now ready to make the presentation to the client and record information from the transaction on the display screen. Once the operator completes the call, he or she presses a designated key on the keyboard to record the status of the contact and terminate the call. The system then makes the operator station available for another call.

### BRIEF SUMMARY OF THE INVENTION

An object of this invention is the provision of a system that uses call originating management technology to place and track voice call backs in response to user requests via a web page input.

Briefly, this invention contemplates the provision of a voice call back system for a user connected to a web server. In response to a user response to a prompt or icon on the screen of the user's terminal, the server downloads a call back screen to be filled in by the user. The name and telephone number of the user are entered by the user on the screen along with a user selected call back time. This data is transmitted to the web server. An application on the server converts this data to a format required by a call manager server in the call originating management system. The call manager creates a call record and appends the call record to the file of an active outbound campaign. The call manager sends the call record to a call processor in accordance with the user's instructions, and the call processor dials the user phone number, connects the call to an agent, and displays information relevant to the call on the display screen of the agent's terminal.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram of one embodiment of a call back system in accordance with the teachings of this invention.

FIG. 2 is a pictorial view of one example of a display screen downloaded from the web server to the user.

FIG. 3 is a flow diagram of one embodiment of the steps implementing the call back system of this invention.

### DETAILED DESCRIPTION OF THE INVENTION

Referring now to FIG. 1, in this exemplary embodiment of the invention, an internet connection 12 connects a user terminal 14 to a web server 16. A data link 18 connects the web server 16 to a call originating management system that includes a call manager 20 and a call processor 22. A publicly switched telephone system 24 provides a voice connection between the user's telephone set 26 and the telephone set 28 of the agent assigned to the user's call. Data relative to the called back user can be displayed on the agent's terminal 30 screen at the same time the agent is connected to the call. As will be appreciated by those of ordinary skill in the art, the components of the just-described system are known in the art and their basic operation need not be described in detail here.

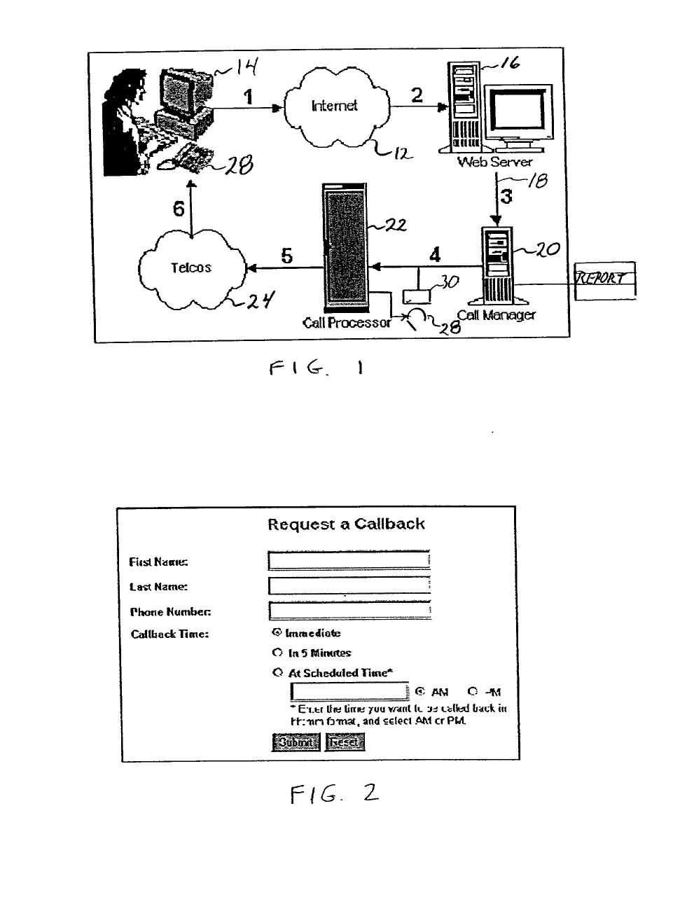

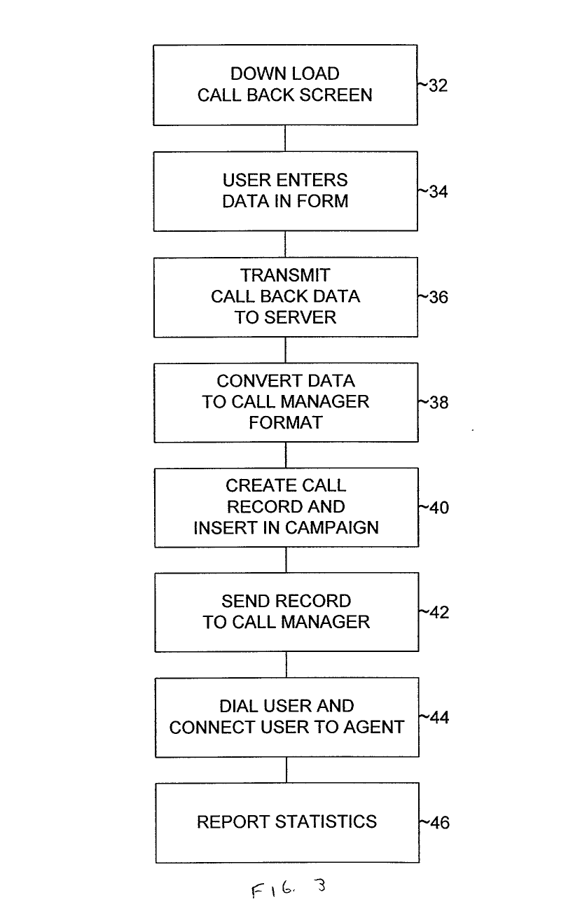

Referring now to FIGS. 2 and 3 in addition to FIG. 1, in operation, the user terminal 14 has an interactive, internet data link 12 to a web site that resides on web server 16. One of the features offered to the user, from the application running on the web site 16, is the voice call back feature. That is, an option to have the system establish a voice interconnection with an agent. To this end, the web site application provides user input (e.g. a click-on icon) in response to which the web site downloads a call back screen (block 32), an example of which is shown in FIG. 2. The user fills in his or her name and telephone number in the fields of the downloaded form, other data requested by the web application, and when the user wants to be called (e.g. immediately, or some specified time and date) block 34. The user terminal transmits to the web site over the internet the data filled in the fields prescribed by the downloaded from, block 36. The web server runs a program that converts the data from an internet compatible format to the format required by the call manager server, block 38. The call manager server 20 creates a call record and inserts it into the IND file of an active outbound campaign, block 40. The call manager 20 sends the call record to the call processor 22 at the time requested by the user, block 42. The call processor dials the user phone number, and if the call is answered, connects the user to an agent's telephone set 28, and displays data relevant to the user's call on the display screen 30 of the agent's terminal, block 44. The call manager provides statistics and reports that can include the number of call back requests received by the system and the call back success rate, block 46.

While the invention has been described in terms of a single preferred embodiment, those skilled in the art will recognize that the invention can be practiced with modification within the spirit and scope of the appended claims.

1. Method for providing a voice call back to a user connected via the internet to a web site, including the steps of:
responding to a user input at a user terminal by downloading from said web site to said terminal a call back form that includes fields for the user's name and telephone number of a telephone set where the user wants to be called and time to call;
transmitting the data in the user name, telephone number, and time to call fields in an internet format to said web site;
converting the user name and telephone number data from said internet format to call processor format;
transmitting the converted user name and telephone number from said web server to a call processor, said call processor creating from said converted user data a call record, entering said call record in the file of an outbound campaign; transmitting said call record to a call processor in accordance with said time to call data;
said call processor placing a call over a public switched network to the telephone set of the user and connecting said user telephone set to an agent's telephone set if said user answers the call.
